(19) United States
(12) Patent Application Publication
(10) Pub. No.: US 2009/0008202 A1
(43) Pub. Date: Jan. 8, 2009

(54) SYSTEMS AND METHODS FOR MASS CUSTOMIZED LUGGAGE

(76) Inventors: Douglas C. Dayton, Harvard, MA (US); Sung K. Park, Newton, MA (US); David Duncanson, West Newbury, MA (US); Tim Proulx, Nashua, NH (US)

Correspondence Address: FISH & RICHARDSON PC, P.O. BOX 1022, MINNEAPOLIS, MN, 55440-1022, US

(21) Appl. No.: 12/144,854

(22) Filed: Jun. 24, 2008

Related U.S. Application Data
(60) Provisional application No. 60/946,160, filed on Jun. 26, 2007.

(51) Int. Cl. A45C 3/00; G09F 19/00

(52) U.S. Cl. 190/100; 190/110; 40/615

(57) ABSTRACT

Embodiments of the present invention may comprise a system and method for mass customizing luggage. A system and method for customizing luggage may comprise offering a user a design catalog from which to select a graphic design for an item of luggage, the item of luggage having a recessed panel, generating a custom label using the selected graphic design, and applying the custom label to the recessed panel.

### CROSS-REFERENCE TO RELATED APPLICATIONS

This application claims the benefit of the following provisional application, which is hereby incorporated by reference in its entirety:

U.S. Provisional Application No. 60/946,160, filed Jun. 26, 2007.

### BACKGROUND

1. Field

The present invention generally relates to mass customized luggage and related systems and methods.

2. Description of the Related Art

Because of the economics of the industry, luggage has little differentiation among the many manufacturers and models available. Most luggage is black and difficult to identify at more than a few feet away. It can be observed in any airport that people desire to customize and personalize their luggage. The present invention enables mass customization of luggage.

### SUMMARY

In an aspect of the invention, a system and method for customizing luggage may comprise offering a user a design catalog from which to select a graphic design for an item of luggage, the item of luggage having a recessed panel, generating a custom label using the selected graphic design, and applying the custom label to the recessed panel. The system and method may further comprise providing a registration mark of the custom label to facilitate alignment of the label with the recessed panel. The system and method may further comprise offering a user a choice of a luggage item adapted to receive the custom label in a recess of the luggage item panel. In an embodiment, the method may further comprise providing an adhesive backing on the label to facilitate affixing the label to the luggage. In an example of this embodiment, a peel-away backing may be disposed below the adhesive to protect the adhesive. Only a portion of the peel-away backing may be removed at a time to facilitate alignment of the label on the recessed panel. In an embodiment, the method may further comprise printing an identification code on the label to facilitate design and order tracking. In an embodiment, printing may comprise at least one of reverse printing on polymer sheets, ink jet printing, laser printing, thermal transfer printing, dye sublimation, silk screening, lenticular printing, blueprinting, and impact printing. In an embodiment, the label may comprise a material resistant to at least one of solvent, heat, water/vapor, x-ray, UV, fade, abrasion, peel, pressure, and temperature. In an embodiment, the method may further comprise an overprint applied to the imprinted label to facilitate retaining ink. In an embodiment, the label may comprise a surface adapted to be imprinted. In an embodiment, the label may comprise at least one of paper, film, foil, plastic, polymeric film, elastomeric film, canvas, and fabric.

In an aspect of the invention, a method for luggage-side advertisement, may comprise receiving an order for a customized luggage item, wherein the customization comprises a label imprinted with user-selected content and associated with an adhesive layer; offering the user a chance to offset the cost of the customized luggage by including a sponsored advertisement with the printed content; calculating the cost of the customized luggage based on a selected sponsored advertisement; printing the custom label with the user-selected content and the sponsored advertisement; and applying the label to the luggage. In an embodiment, the method may further comprise providing an interface whereby advertisers may bid for association of advertisements with content. In an example of this embodiment, the interface may allow an advertiser to select a category of content with which to associate an advertisement. In an embodiment, a bidding interface may present a price for associating an advertisement with content. In an embodiment, an advertiser may use the interface to set preferences for advertisement placement on a design.

In an aspect of the invention, a mass customized luggage may comprise a recessed panel on the luggage, wherein the surface within the recess is adapted to receive a custom label; and a custom label comprising a design selected by a user, printed on to the label, and adhesively applied to the luggage. In an embodiment, the design may be selected from a catalog of designs. In an embodiment, the design may be provided by a user. In an embodiment, the luggage may further comprise a power generator disposed in the wheels of the luggage. In an embodiment, the luggage may further comprise a battery disposed in the body of the luggage. In an embodiment, the luggage may further comprise compression zones. In an embodiment, the luggage may further comprise anti-tip technology. In an embodiment, the luggage may further comprise a built-in shoe rack. In an embodiment, the luggage may further comprise a custom luggage tag. In an embodiment, the luggage may further comprise a custom name plate.

In an aspect of the invention, a system and method for mass customization of luggage may comprise a custom order facility for selecting a luggage customization, comprising: a design catalog facility, a custom design facility, a print facility, a luggage choice facility, a user profile, and a cost basis facility; a fulfillment facility for assembling a customized luggage, comprising: a luggage handling facility, a registration facility, a label handling facility, an order tracking facility; and a revenue sharing facility for offsetting the cost of a customized luggage with an advertisement, comprising: a design tracking facility, an advertisement offer facility, an advertiser interface, and an advertiser bidding facility. In the system and method, the design catalog facility may facilitate selecting a design to use on a custom label for application to a luggage item. In the system and method, the design catalog facility may provide suggestions for a design based on a user profile. In the system and method, when a design is chosen from the design catalog facility, the design tracking facility may update an accounting database with which design was chosen. In the system and method, the label handling facility may scan an identification code identifying the design printed on the label and updates an accounting database with the identity of the design. In the system and method, the advertisement offer facility may provide a user an opportunity to offset the cost of the customization order by including a sponsored advertisement with a printed custom label. In the system and method, if a user selects an advertisement offer, a cost basis facility may provide an updated cost of the custom luggage item with the selected design. In the system and method, the advertiser bidding facility may enable advertisers to bid for association of their advertisements with particular designs offered through the design catalog facility. In the system and method, the print facility may facilitate at least one of selecting a label sized to fit on a surface of the luggage, selecting a label sized to accommodate the chosen design, choosing a printing technique, and selecting a label-type suited for the design. In the system and method, the luggage handling facility may retrieve a chosen item of luggage based on a luggage identifier and places it on a conveyor belt for transport to a registration facility. In the system and method, the label handling facility may facilitate providing the printed labels from the print facility to the registration facility. In the system and method, the label handling facility may comprise at least one of a camera, a scanner or other imaging device, a conveyor belt, a chute, and a robotic device. In the system and method, the registration facility may comprise at least one of a camera, scanner, an imaging device, a roller, and a level.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a system for mass customization of luggage.

FIG. 2 depicts a luggage item with recessed panels adapted to receive a custom label.

FIG. 3 depicts a label application assembly line.

FIG. 4 depicts a luggage item with a transparent panel adapted to receive a design.

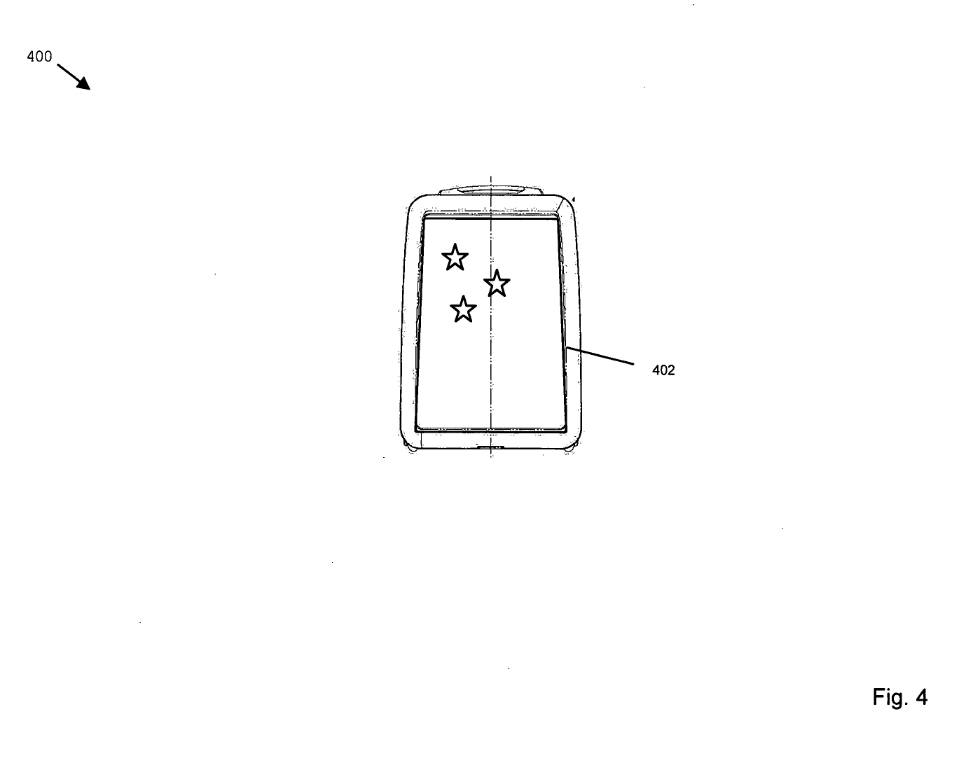

FIG. 5 depicts a luggage item with a pocket adapted to receive a design.

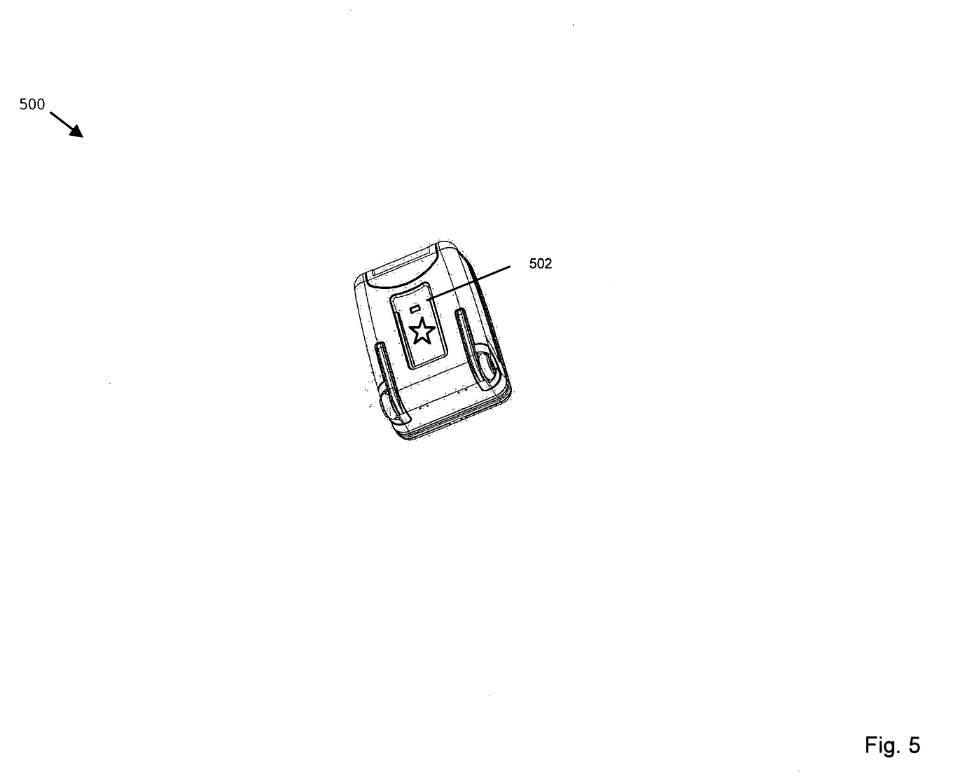

### DETAILED DESCRIPTION

Systems and methods for mass customized luggage involve methods for mass customization of luggage, methods for luggage-side advertisements, methods for identifying luggage by mass customization, and the like. A system for mass customization of luggage may involve at least one of designing a custom label, applying a custom label to a panel of luggage wherein the label may be adapted to fit on a side of the luggage, tracking designs chosen for labels for purposes of revenue sharing, and offering a sponsorship to defray the cost of customized luggage.

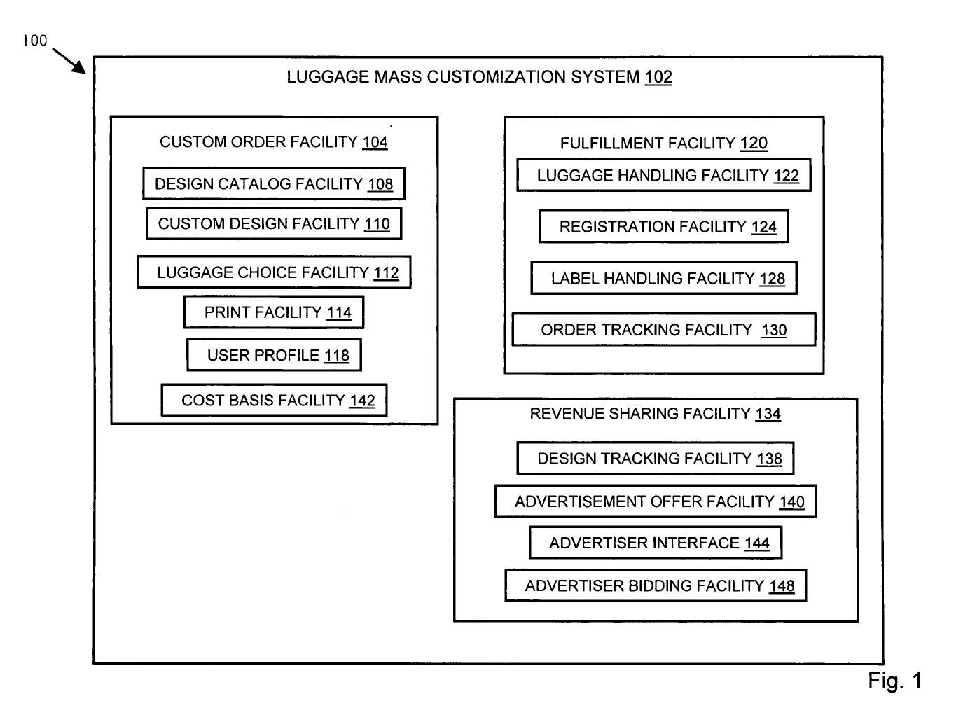

Referring to FIG. 1, a luggage mass customization system 102 may comprise a custom order facility 104, a fulfillment facility 120, and a revenue sharing facility 134. The custom order facility 104 may comprise a design catalog facility 108, a custom design facility 110, a print facility 114, a luggage choice facility 112, a user profile 118, a cost basis facility 142, and the like. The fulfillment facility 120 may comprise a luggage handling facility 122, a registration facility 124, a label handling facility 128, an order tracking facility 130, and the like. The revenue sharing facility 134 may comprise a design tracking facility 138, an advertisement offer facility 140, an advertiser interface 144, an advertiser bidding facility, and the like.

In an embodiment, the custom order facility 104 may comprise an internet or mobile ordering system, an automated telephone system, a telephone operator-mediated ordering system, and the like. For example, a user may access an internet page to place an order for a piece of customized luggage. When a user may access a custom order facility 104, they may be given the opportunity to select a design catalog facility 108, a custom design facility 110, a luggage choice facility 112, an order tracking facility 130, and the like. A user may select any of the facilities in any order. For example, the user may first select the design catalog facility 108 to select a design and then the luggage choice facility 112 to select a luggage to customize. When a user may first access the custom order facility 104, they may be given the opportunity to create a user profile 118. The user profile 118 may comprise personal information, billing information, shipping information, interests, affiliations, schools, jobs, and the like.

In an embodiment, a user may access a design catalog facility 108 of the custom order facility 104. A user may use the design catalog facility 108 to select a design to use on a custom label for application to a piece of luggage, thus customizing the luggage to their liking. In an embodiment, the label may be imprinted with the user-chosen design. The design may comprise at least one of a solid color, a print, a print with different color palettes, a holograph, a texture, a licensed content, an affiliation, a photo, a blank slate, a user-generated design, and the like. The licensed content may be a sport logo; a sport figure/mascot; a character/entertainer, such as from film, television, music, gaming, animation, the arts, and the like; a celebrity/persona, an artwork reproduction, a corporate logo, a brand, a trademark, and the like. The affiliation may be a school, a corporation, a club, an organization, a local sports organization, a hobby group, a seminar, a trade show, a meeting, a culture, a nation, a lifestyle, a political party, a religion, a company, and the like. The photo may be of a user of the luggage, family, pets, sites, landmarks, art, landscapes, humor, and the like. The blank slate may comprise a material that can be drawn on, painted on, or otherwise customized by a user. The design catalog facility 108 may provide suggestions for designs. The suggestions may be made based on a user profile 118. For example, a user profile 118 may comprise information such as a user's gender, address, area code, college affiliation, job, and the like. The suggestions may be for categories of design, specific designs, and the like.

In an embodiment, a cost basis facility 142 may be integrated with the design catalog facility 108. When a user may select a design for their order, the initial cost of the design may be calculated by the cost basis facility 142. For example, the cost for a design comprising licensed content may be higher than a design comprising a simple striped pattern.

In an embodiment, the design catalog facility 108 may be integrated with a revenue sharing facility 134. When designs may be chosen from the design catalog facility 108, a design tracking facility 138 may update an accounting database with which design was chosen, and later when a user selects placement positions on the luggage, how many instances of the design may be used. The design tracking facility 138 may facilitate proper compensation to any copyright holders for use of any copyrighted material in the chosen designs. As an internal check, when a design may be printed on a label, an identification code identifying the design may be printed on the label along with the design. The label handling facility 128 may scan the identification code and update an accounting database with the identity of the design.

In an embodiment, the label may be designed by a user using the custom design facility 110. A user may select or create a design and provide it to the system using the custom design facility 110. The custom design facility 110 may be an internet upload facility, a facsimile service, and the like. In an alternative embodiment, the user may mail the design to an operator of the system. In any event, the designs, whether uploaded, faxed, mailed, or the like, may be processed for printing.

In an embodiment, an advertisement offer facility 140 may be integrated with the design catalog facility 108. The advertisement offer facility 140 may provide a user an opportunity to offset the cost of the customization order by including a sponsored advertisement with the printed custom label. The advertisement offer facility 140 may tailor the offer by presenting specific advertisements that may be in the same category as the design. For example, a user may choose a Boston Red Sox logo to be printed as a custom label for a hard shell bag. The advertisement offer facility 140 may select a sponsored advertisement that may be in the same sports category as the Boston Red Sox. The user may be presented with an advertisement offer, such as from ESPN, Nike, Sports Illustrated, and the like. If a user may select an advertisement offer, a cost basis facility 142 may provide an updated cost for the selected design. For example, a user may select a Bart Simpson image for customizing a hard shell golf bag, wherein the total cost may be $200. The user may be offered the option of including an advertisement selected from the Cartoon Network, the PGA, Titleist, Avon, and the like. The total cost for the bag may decrease with the number of advertisements selected, the specific advertiser offering an advertisement, whether the advertisement is in the same category as the design and/or the luggage, an advertiser-determined cost reduction, and the like. For example, choosing the Avon advertisement may reduce the total cost of the customized bag by $5 whereas choosing the Titleist advertisement may reduce the total cost by $30.

In an embodiment, the advertisement offer facility 140 may be optional. A user may opt out of receiving any advertisement offers at any time, such as during the creation of the user profile 118.

In an embodiment, an advertiser may use an advertiser interface 144 to select advertisements to offer for association with designs, select a category to place an advertisement in, modify or delete advertisements, and the like. The advertiser interface 144 may be used to set preferences. An advertiser may specify that certain advertisers may not advertise on the same design, certain advertisements may not appear on specific designs, and the like.

In an embodiment, an advertiser bidding facility 148 may enable advertisers to bid for association of their advertisements with designs. For example, an advertiser may bid to be the exclusive advertiser with any Major League Baseball designs. The advertiser bidding facility 148 may present a price for associating an advertisement with a design. For example, the cost for associating an advertisement with a Boston Red Sox design may be greater than the cost for associating an advertisement with a local college sports team logo.

In an embodiment, a user may access the luggage choice facility 112 to select a piece of luggage for customization. In an embodiment, the label may be adapted to be applied to various types of luggage. The luggage may be a hard shell bag, a soft side bag, a fabric bag, a tear resistant bag, a leather bag, a bag made from sports ball materials, such as football rawhide and the like, a computer bag, a golf bag, a musical instrument case, a backpack, a garment bag, a duffel bag, a toiletry case, a lunch case, a motorcycle saddle pack, a cooler, and the like. The luggage choice facility 112 may provide suggestions to a user. The suggestions may be based on a user profile 118, luggage cost, a chosen design, and the like. Once a luggage may be selected, the cost basis facility 142 may be updated with the price for the luggage.

In an alternative embodiment, a user may select to customize a piece of luggage they already own. In this event, the user may provide the luggage to the system or provide the measurements of the space to be customized.

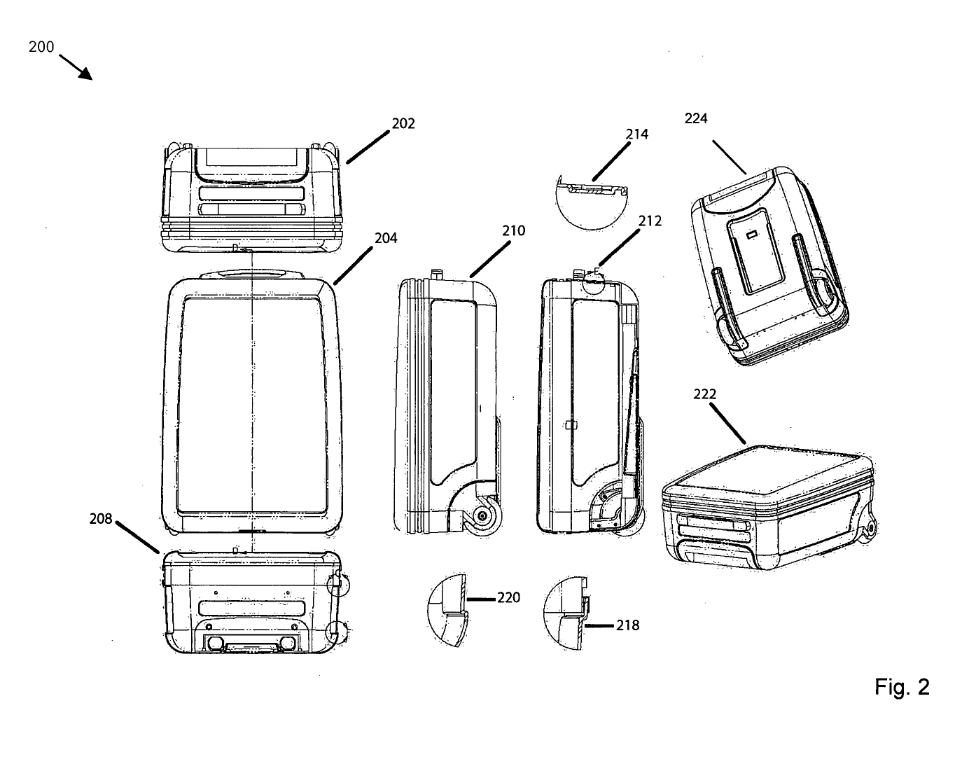

In an embodiment, a number of standard pieces of luggage may be offered through the luggage choice facility 112. Some pieces of luggage may have recessed surfaces. Referring to FIG. 2, recessed surfaces may allow a label to be adhered to the surface of the luggage wherein the outer edge of the recessed surface provides protection from abrasion, peeling, tearing, ripping, soiling, and the like. For example, a label may be adhered to various surfaces of a luggage such as a front surface 204, a side surface 210, a side surface 212, a back surface 224, a transparent panel 402, a pocket 502, or multiple surfaces 222. The recessed surface is clearly visible in 208 and 222, and shown in greater detail in 214, 218, and 220. Not all surfaces of the luggage may be recessed. Labels may be applied to either recessed or non-recessed surfaces. In an embodiment, the back surface 224 may comprise skid strips, a recess, an identification pouch, and the like.

In an embodiment, the custom order facility 104 may comprise a tool for designing the luggage customization. For example, a rolling hard shell suitcase may present multiple recessed or non-recessed surfaces for customization, such as the two large sides of the suitcase, the two edges of the case, the top of the case, and the bottom of the case. A user may use the custom order facility 104 to select which if the surfaces on the suitcase to customize. For example, a user may choose to only customize the two large sides of the case and leave the other surfaces without customization. If a design may be already chosen when the custom order facility 104 is accessed, the design may appear on the surfaces chosen for customization. The user may use the custom order facility 104 to re-size and position the design for placement on the selected surface of the luggage. The design tracking facility 138 may note how many instances of a particular design may be chosen for placement by a user. The cost basis facility 142 may update the price of the customized luggage based on any re-sizing or multiple design usage.

In an embodiment, a print facility 114 may be accessed after a user has selected or created a design, selected a piece of luggage to customize with the design, and selected the surfaces of the chosen luggage to customize. The print facility 114 may facilitate selecting a label sized to fit on a surface of the luggage and accommodate the chosen design. The print facility 114 may be used to print the chosen design onto a label. In an embodiment, the print facility 114 may comprise at least one of reverse printing on polymer sheets, ink jet printing, laser printing, thermal transfer printing, dye sublimation, silk screening, lenticular printing, blueprinting, impact printing, and the like. In an embodiment, various inks may be used in printing the label with the print facility 114. The inks may comprise glow-in-the-dark inks, day-glo inks, electroluminescent ink, solvent-based inks, water-based inks, dye-based inks, pigment-based inks, fluorescent inks, and the like. In an embodiment, the label may comprise a material resistant to at least one of solvent, heat, water/vapor, x-ray, UV, fade, abrasion, peel, pressure, temperature, and the like. In an embodiment, an overprint may be applied to the imprinted label to facilitate retaining ink. In an embodiment, the label may comprise a surface adapted to be printed on. The label may be paper, film, foil, plastic, canvas, fabric, and the like. The film may be a polymeric film, an elastomeric film, and the like. In an embodiment, the print facility 114 may facilitate choosing a printing technique and a label-type suited for the design. For example, if a photo is to be printed, the print facility 114 may choose a dye sublimation print technique and a photo-receptive film.

In an embodiment, the label may be supported by a carrier sheet. The label may be releasably affixed or adhesively affixed to the carrier sheet. In embodiments, when the label is adhesively fixed to the carrier sheet, after printing label the carrier sheet may be retained as a peel-away backing. The carrier sheet may be of a size compatible for use in a variety of print facilities 114.

In an embodiment, the label may comprise an adhesive backing. The adhesive may be a pressure-sensitive adhesive, a semi-permanent adhesive, a permanent adhesive, and the like. In embodiments, a peel away backing may be disposed over the adhesive backing in order to protect the adhesive from contamination prior to application.

In an embodiment, once a label may be printed and a luggage may be selected, the fulfillment facility 120 may facilitate assembling the printed label on the luggage to obtain the customized luggage. Alternatively, the fulfillment facility 120 may facilitate assembling the printed label along with the luggage for distribution to a distribution center, a user pick-up center, a user's home, and the like. In this embodiment, the distributor or the user may bear the task of adhering the label to the luggage.

In an embodiment, a luggage handling facility 122 may facilitate obtaining the chosen luggage from a warehouse, manufacturer, storage area, and the like. For example, when an order may be received by the luggage handling facility, a luggage identifier may be included in the order. An individual may note the luggage identifier, retrieve the piece of luggage with the luggage identifier and place it on a conveyor belt for transport to a registration facility 124. In another example, a robot or some other machinery may automatically retrieve a piece of luggage from a warehouse, manufacturer, storage area, and the like when the robot receives a command with an associated luggage identifier. The robot may retrieve the luggage and transport it to a registration facility 124 or hand it off to another facility for transport to a registration facility 124. The luggage handling facility 122 may also facilitate keeping an inventory of the luggage. The luggage handling facility 122 may provide the luggage to a registration facility 124.

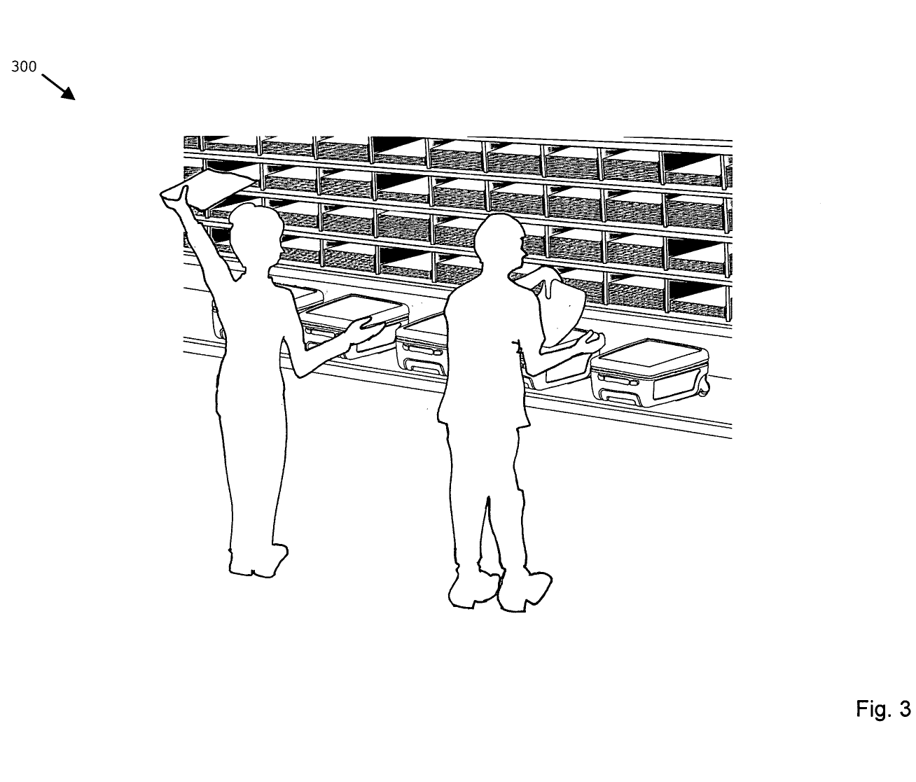

In an embodiment, a label handling facility 128 may facilitate providing the printed labels from the print facility 114 to the registration facility 124. The label handling facility may comprise a camera, scanner, or other imaging device; and a conveyor belt, chute, robotic arm, or other distribution means. In some embodiments, the printed label may comprise an identification code that may be read by the label handling facility 128. The identification code may identify the design, the order number, the location in the registration facility 124 to provide the label, and the like. In embodiments, multiple copies of a label may be printed by the print facility 114 and provided to a registration facility 124 by the label handling facility 128. If there may be no existing order a customized luggage including the multiply copied label, the labels may be stored at a registration facility 124 until needed. For example, when a design may be selected through the design catalog facility 108, the design tracking facility 138 may be accessed to determine if a label may have already been printed previously and stored. If a label already exists, the label handling facility 128 may be directed to access printed labels from storage rather than the print facility 114 in order to provide the user chosen design and label to a registration facility 124. Storage for pre-printed labels may be located near a registration facility 124 to facilitate access. As in FIG. 3, storage may be in a series of storage spaces. Each storage space may be labeled for ease of identifying the labels contained therein, either by a label handling facility 128 or an individual. Storage may also be in a pop-up dispenser, a perforated roll, an automatic dispenser, and the like. An order tracking facility 130 may also receive information regarding the identification code when it may be scanned in order to track orders through the mass customization process.

In an embodiment, the registration facility 124 may comprise a camera, scanner, an imaging device for locating the edges of a label, a laser level, and the like. Locating the edges of the label may be facilitated locating a printed registration mark or machine-readable indicia on the label. The registration mark may be pre-printed on the labels or may be printed along with the design. The registration facility 124 may ensure proper alignment of the label with a surface of the luggage. Once a proper alignment may be determined, the label may be ready to be applied to the surface. In an embodiment, a peel away backing on an adhesive label may be partially or entirely removed and the label may be lowered in place on the surface of the luggage. The registration facility 124 may further comprise a roller to firmly affix the label to the surface of the luggage. In some embodiments, the peel away backing may be designed to initially peel away partially to facilitate placement of the label on the luggage. For example, the peel away backing may have a central peel away strip, wherein peeling away the central strip exposes only the portion of the adhesive backing disposed below the central strip. The label may be aligned on the luggage as described herein and adhered along the central strip portion. Once aligned and partially adhered, the remainder of the peel away backing may be removed in order to adhere the remaining portions of the adhesive label to the surface of the luggage.

In an embodiment, the adhesive may be disposed on the luggage prior to adhering the label. The adhesive may be sprayed on, painted on, deposited, rolled on, and the like. For example, for labels where there may be no adhesive backing, the label may be applied to the luggage with pre-application of adhesive to the surface of the luggage or to the label itself.

In an embodiment, the label may be applied to the luggage by various other methods. For example, the luggage may comprise a transparent panel 402 or pouch on the bag with an opening adapted to receive a custom label. A custom label may be disposed behind the transparent panel 402 such that it is visible through the transparent panel 402. The label may be secured behind the transparent panel 402 by an adhesive edge, a zipper along an edge of the panel, a gasket around the panel, a snap sealing the panel against the luggage, a hook-and-loop fastener for sealing the edge of the panel to the luggage, a thermal seal, a chemical seal, a sewn edge, and the like. In an embodiment, a user may insert additional materials behind the transparent panel 402, such as photos, children's artwork, and the like.

In an embodiment, the custom label may be attached to a pocket 502 of a soft bag. In an embodiment, the custom label itself may be used to form a pocket 502 of a soft bag. The custom label or pocket 502 may be attached or applied to the bag by a zip, rivet, snap, glue, Velcro, press-lock, gasket, embroidery, heat transfer, stenciling, silk-screening, stitching, applying an appliqué, or some other type of attaching means. In embodiments, the pocket 502 may be used as a travel document or personal item storage pocket 502. In an embodiment, the pocket 502 may be reversible.

In an embodiment, the label may be removable. The label may be applied to the bag using electrostatic cling, a light adhesive, a magnet, a snap, a hook and loop fastener, a zipper, a continuous perimeter fastening, extruded or molded plastic “zip-lok” connectors, linear insertable gaskets, sewing, and the like.

In an embodiment, the label may be imprinted on a panel that may attach to a surface of a luggage. The panel may be plastic, metal, elastomeric, polymeric, and the like. The panel may be imprinted as described herein. The panel may be removable or permanently affixed. The panel may be attached to the luggage by being slid in along runners along an outer edge of a luggage, sewn on, attached by a magnet, a snap, a hook and loop fastener, a zipper, a screw, a continuous perimeter fastening, extruded or molded plastic “zip-lok” connectors, linear insertable gaskets, and the like. In an embodiment, the panel may be reversible.

In another embodiment, the luggage mass customization 102 system may be operated by individuals. An individual may receive an order from the custom order facility 104 and either print the chosen design on a label using a print facility 114 or retrieve a pre-printed label from storage. Then the luggage chosen by a user with the luggage choice facility 112 may be retrieved and both label and luggage may be brought to a registration facility 124 to facilitate application of the label to the luggage. The label may be applied by an individual either by hand or with use of the registration facility 124. For example, a laser level may be used to align the label with an edge of a luggage recess.

In an embodiment, once the customized luggage may be assembled, the customized luggage may be distributed to a distribution center, a user, and the like. A user may choose to have their luggage hand-delivered or shipped to them. In another embodiment, a user may choose to pick-up the luggage at a distribution center.

In an embodiment, the luggage may comprise additional features. For example, the luggage may comprise a generator, a battery, or both. For example, as the luggage device is wheeled, energy generated by a generator associated with the luggage wheels may be applied to various devices integrated with the luggage. Either the battery, the generated power, or both may be used to power various devices associated with the luggage, such as a power outlet, a WiFi locator, a clock, a custom computer, a PDA, a calculator, an expense counter, a cell phone, a GPS device, a luggage locating device with at least one of a wireless transmitter/receiver or RF transmitter/receiver, and the like. The battery or the generator may be switched on or off with a switch, lever, retraction or extension of a luggage handle, and the like. In an embodiment, the luggage may also comprise a Name Plate. In an embodiment, the luggage may comprise a luggage tag. The luggage tag may be customized as described herein. The luggage tag may comprise an RFID tag for identification, location, information storage, and the like. In an embodiment, the luggage may comprise anti-tip technology. In an embodiment, the luggage may comprise a suspension. In an embodiment, the anti-tip technology may be integrated with the luggage suspension. In an embodiment, the luggage may comprise compression zones. In an embodiment, the luggage may comprise a built-in shoe rack. In an embodiment, the luggage may comprise skid strips.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method for customizing luggage, comprising:
offering a user a design catalog from which to select a graphic design for an item of luggage, the item of luggage having a recessed panel;
generating a custom label using the selected graphic design; and
applying the custom label to the recessed panel.

2. The method of claim 1, further comprising, providing a registration mark of the custom label to facilitate alignment of the label with the recessed panel.

3. The method of claim 1, further comprising, offering a user a choice of a luggage item adapted to receive the custom label in a recess of the luggage item panel.

4. The method of claim 1, further comprising disposing an adhesive backing on the label to facilitate affixing the label to the luggage.

5. The method of claim 4, wherein a peel-away backing is disposed below the adhesive to protect the adhesive.

6. The method of claim 5, wherein only a portion of the peel-away backing is removed at a time to facilitate alignment of the label on the recessed panel.

7. The method of claim 1, further comprising printing an identification code on the custom label to facilitate design and order tracking.

8. The method of claim 1, wherein generating the custom label comprises at least one of reverse printing on polymer sheets, ink jet printing, laser printing, thermal transfer printing, dye sublimation, silk screening, lenticular printing, blueprinting, and impact printing.

9. The method of claim 1, wherein the custom label comprises a material resistant to at least one of solvent, heat, water/vapor, x-ray, UV, fade, abrasion, peel, pressure, and temperature.

10. The method of claim 1, further comprising an overprint applied to the custom label to facilitate retaining ink.

11. The method of claim 1, wherein the label comprises a surface adapted to be imprinted.

12. The method of claim 1, wherein the custom label comprises at least one of paper, film, foil, plastic, polymeric film, elastomeric film, canvas, and fabric.

13. A system for customizing luggage, comprising:
a design catalog that allows a user to select a graphic design for an item of luggage, the item of luggage having a recessed panel; and
a custom label generated using the selected graphic design,
wherein the recessed panel is adapted to receive the custom label.

14. The system of claim 13, further comprising, providing a registration mark of the custom label to facilitate alignment of the label with the recessed panel.

15. The system of claim 13, further comprising, offering a user a choice of a luggage item adapted to receive the custom label in a recess of the luggage item panel.

16. The system of claim 13, further comprising disposing an adhesive backing on the label to facilitate affixing the label to the luggage.

17. The system of claim 16, wherein a peel-away backing is disposed below the adhesive to protect the adhesive.

18. The system of claim 17, wherein only a portion of the peel-away backing is removed at a time to facilitate alignment of the label on the recessed panel.

19. The system of claim 13, further comprising printing an identification code on the custom label to facilitate design and order tracking.

20. The system of claim 13, wherein generating the custom label comprises at least one of reverse printing on polymer sheets, ink jet printing, laser printing, thermal transfer printing, dye sublimation, silk screening, lenticular printing, blueprinting, and impact printing.

21. The system of claim 13, wherein the custom label comprises a material resistant to at least one of solvent, heat, water/vapor, x-ray, UV, fade, abrasion, peel, pressure, and temperature.

22. The system of claim 13, further comprising an overprint applied to the custom label to facilitate retaining ink.

23. The system of claim 13, wherein the label comprises a surface adapted to be imprinted.

24. The system of claim 13, wherein the custom label comprises at least one of paper, film, foil, plastic, polymeric film, elastomeric film, canvas, and fabric.

25. A method for luggage-side advertisement, comprising:
receiving an order for a customized luggage item, wherein the customization uses a label imprinted with user-selected content and associated with an adhesive layer;
offering the user a chance to offset the cost of the customized luggage by including a sponsored advertisement with the user content;
calculating the cost of the customized luggage based on a selected sponsored advertisement;
printing the custom label with the user-selected content and the sponsored advertisement; and
applying the label to the luggage.

26-29. (canceled)

30. A luggage device, comprising:
a recessed panel on a face of the luggage device; and
a custom label comprising a design selected by a user, wherein the design is printed on the custom label along with a registration mark, the recessed panel is adapted to receive the custom label, and the custom label can be scanned for the registration mark to facilitate aligning the custom label with the recessed panel of the luggage.

31-41. (canceled)

42. The luggage device of claim 30, wherein the custom label forms a pocket on the luggage device when it is applied to the recessed panel.

43. A luggage device, comprising:
a transparent panel on the luggage device and
a custom label having a design selected by a user, printed thereon, wherein the panel comprises an opening adapted to receive the custom label, and the custom label is disposed behind or within the transparent panel of the luggage.

44-55. (canceled)

56. A luggage device, comprising:
a pocket on the luggage device; and
a custom label comprising a design selected by a user, wherein the design is applied to the custom label along with a registration mark, the pocket is adapted to receive the custom label, and the custom label can be scanned for the registration mark to facilitate aligning the custom label with the pocket of the luggage device.

57. The luggage device of claim 56, wherein the design is selected from a catalog of designs.

58. The luggage device of claim 56, wherein the design is provided by a user.

59-63. (canceled)

64. The luggage device of claim 56, wherein the custom label is secured on the pocket by at least one of an adhesive edge, a zipped edge, a rivet, a snap, a press-lock connection, embroidery, stenciling, silk-screening, an appliqué, a gasket around the pocket a hook-and-loop fastener, a thermal seal, a chemical seal, and a sewn edge.

65. The luggage device of claim 56, wherein the pocket is adapted to receive additional materials in addition to the custom label.

66. The luggage device of claim 56, wherein the pocket is reversible.

67. The luggage device of claim 56, wherein the label is removable.

68. A system for mass customization of luggage, comprising:
a custom order facility for selecting a luggage customization, comprising: a design catalog facility, a custom design facility, a print facility, a luggage choice facility, a user profile, and a cost basis facility;
a fulfillment facility for assembling a customized luggage, comprising: a luggage handling facility, a registration facility, a label handling facility, an order tracking facility; and
a revenue sharing facility for offsetting the cost of a customized luggage with an advertisement, comprising: a design tracking facility, an advertisement offer facility, an advertiser interface, and an advertiser bidding facility.

69-80. (canceled)

81. A method for mass customization of luggage, comprising:
facilitating selection of a luggage customization with a custom order facility, the custom order facility comprising a design catalog facility, a custom design facility, a print facility, a luggage choice facility, a user profile, and a cost basis facility;
facilitating assembling a customized luggage with a fulfillment facility, the fulfillment facility comprising: a luggage handling facility, a registration facility, a label handling facility, an order tracking facility; and
offsetting the cost of a customized luggage with an advertisement selected through a revenue sharing facility, the revenue sharing facility comprising: a design tracking facility, an advertisement offer facility, an advertiser interface, and an advertiser bidding facility.

82-93. (canceled)

94. The luggage device of claim 55, wherein the design is printed on the custom label.

95. The luggage device of claim 56, wherein the pocket is attached to the luggage device by at least one of an adhesive edge, a zipped edge, a rivet, a snap, a press-lock connection, embroidery, stenciling, silk-screening, an appliqué, a gasket around the pocket a hook-and-loop fastener, a thermal seal, a chemical seal, and a sewn edge.
